(19) United States
(12) Patent Application Publication
(10) Pub. No.: US 2008/0301016 A1
(43) Pub. Date: Dec. 4, 2008

(54) Method, System, and Computer Program Product for Customer Linking and Identification Capability for Institutions

(75) Inventors: Sastry Vsm Durvasula, Phoenix, AZ (US); Venkata Prathipati, Scottsdale, AZ (US); Sandeep Sacheti, Edison, NJ (US); Laxminarayana Somayaji, Phoenix, AZ (US); Frank J. Straka, Phoenix, AZ (US); Jessica Taizin Lu, Scottsdale, AZ (US); Mary Weissman, Mesa, AZ (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc. General Counsel's Office, New York, NY (US)

(21) Appl. No.: 11/755,313

(22) Filed: May 30, 2007

(51) Int. Cl. G06Q 40/00

(52) U.S. Cl. 705/35

(57) ABSTRACT

In an enterprise where a database maintains multiple accounts for one or more business customers, a method, system, and computer program product correctly links accounts which are associated with a single location of a common business. Further hierarchical linkages are established between accounts associated with multiple locations of the common business. The linkages are established via matching rules, the matching rules including provisions for optimizing the quality of the account data, integrating account-related data from external sources, and assigning quality-of-matching factors to different kinds of account data. Both internal and external account data are utilized to create an integrated view, or “business demographics”, of the business structure of the single common business shared by the linked, hierarchically-related accounts. Separate accounts of separate businesses which are nonetheless related accounts may be associated with each other. Feedback loops may be used to correct both erroneous data and the linking rules.

### BACKGROUND OF THE INVENTION

1. Field of the Invention

The present invention generally relates to managing business customer information, and more particularly to linking business customer accounts within a database.

2. Related Art

Businesses and other institutional clients often have more than one account established through a particular enterprise, especially with a service-oriented enterprise such as a financial services enterprise or an insurance enterprise. In the case of an enterprise of the financial services industry, for example, a single business customer may have any combination of one or more bank accounts, lines of credit, business credit cards, and investment accounts with the single financial enterprise. For an enterprise in the insurance business, a single business customer of the enterprise may have any combination of health insurance, property insurance, liability insurance, and other kinds of insurance protection as well.

In some cases, the enterprise database may reflect that different accounts may be associated with different names or entities of the same business, even if these various entities share a common address. In still other cases, various accounts in the enterprise database may be listed with variations of the same address. Some different accounts of the same business may even use post office box addresses or other alternate addresses rather than direct mailing addresses, all to describe what is actually a single physical location of the business.

In addition, a single business may operate out of multiple business locations, typically though not necessarily with one location being a main headquarters, while other locations function in various subsidiary capacities.

As a result, during the process of contacting a business for marketing or other purposes, an enterprise may make redundant contacts, e.g., distributing marketing literature to multiple locations of the same business. If the same business location is listed in an enterprise database with two variations on the same address, or two variations on the same contact name, the same location or contact person may even be contacted twice by the enterprise. Equally problematic, an enterprise may contact these multiple channels of the same business with different or inconsistent information, such as different marketing offers related to the same product. These multiple contacts increase the cost for an enterprise of marketing to or otherwise contacting businesses, and further result in inconsistent contact approaches.

Further, a business may express preferences about how it is to be contacted. However, if the different locations or executives of the business are not recognized as actually belonging to the common business, these preferences may not be consistently respected by the enterprise as the enterprise contacts different locations, business units, or staff within the business.

Still further, when an enterprise seeks to market additional services or provide customer support services to a particular, existing business customer, the enterprise benefits from having an integrated, holistic view of the business structure and business operations of that particular business customer. Yet when various accounts of a single business customer are erroneously seen—from the perspective of an enterprise database—as separate accounts of separate customers, it is difficult or impossible for the enterprise to achieve the desired integration of business information across all accounts of the given, single business customer. This impedes the ability to provide the desired quality of marketing and support directed towards any given, particular business customer.

Given the foregoing, what is needed then is a system, method, and computer program product for ensuring that multiple account listings maintained by an enterprise for a common business or common institution are linked together, so that consistent contact, marketing, support, and related policies may be established and implemented, so that business customer preferences may be respected in most or all contacts with the business, and so that a consistent and complete picture of the business customer may be maintained across most or all accounts of the business customer.

### BRIEF SUMMARY OF THE INVENTION

A method, system, and computer program product for linking customer information for businesses or other institutions is provided. This is referred to as the customer linking and identification capability for institutions (iCLIC).

In one embodiment of the invention, business account data from a plurality of internal and external data sources is collected. An analysis is performed using a plurality of matching rules to determine which accounts are actually accounts of the same business or institution. Linkages are then created between a plurality of accounts associated with a single, particular location of a single business or institution, by assigning a common, unique, persistent ID shared by the plurality of such accounts of the business/institution.

Further processing may establish a series of hierarchical linkages between different locations of the business and therefore, implicitly or explicitly, between accounts associated with different locations of the business.

Detailed information about the business, which may include earnings and other financial statistics, names of key executives, product lines, and similar data, may be collected and consolidated across a plurality of business units at a plurality of locations of the single business. This consolidated data is collectively referred to as “business demographics” (sometimes referred to in the art as “firmographics”), and delivers to the enterprise a consistent picture of the business for marketing, customer support, and related purposes.

Another kind of linkage, referred to as an “association”, may be established between accounts which may actually belong to separate businesses or institutions, but which are nonetheless related in some way. These associations between accounts provide further insight into a business for marketing, customer support, and related purposes.

Further embodiments, features, and advantages of the present invention, as well as the structure and operation of the various embodiments of the present invention, are described in detail below with reference to the accompanying drawings.

### BRIEF DESCRIPTION OF THE DRAWINGS/FIGURES

The features and advantages of the present invention will become more apparent from the detailed description set forth below when taken in conjunction with the drawings in which like reference numbers indicate identical or functionally similar elements. Additionally, the left-most digit or digits of a reference number identifies the drawing in which the reference number first appears.

FIG. 1 is a flowchart illustrating an exemplary customer linking and identification capability for institutions (iCLIC) process according to one embodiment of the present invention.

FIG. 2 illustrates the process of linking accounts and assigning hierarchical relations among accounts of a common business according to one embodiment of the present invention.

FIG. 3 illustrates exemplary business demographics associated with an exemplary iCLIC hierarchy according to one embodiment of the present invention.

FIG. 4 illustrates an exemplary associative linking of two accounts according to one embodiment of the present invention.

FIG. 5 is a block diagram of an exemplary computer system useful for implementing the present invention.

### DETAILED DESCRIPTION OF THE INVENTION

### I. Introduction

A method, system, and computer program product for linking business and/or other institutional customer accounts is presented, where such accounts may be stored, processed, and maintained within a business database or other organizational or institutional database maintained by an enterprise.

The method, system, and computer program product link the business customer accounts and or other institutional customer accounts that may all be accounts of a common business. It should be understood that while the method, system, and computer program product are described here in the context of managing records of businesses, business activities, and business customer and account databases implemented in an enterprise context, the method, system, and computer program product could as well be implemented and applied in other contexts as well.

For example, the method, system, and computer program product described herein could be used to link accounts of a non-commercial nature which may be related to a common, unique organization described in a database implemented in a non-commercial and non-business context. Such organizations might include, for example and without limitation, governmental organizations, schools, charities or other non-profit organizations, or religious organizations.

The present invention is now described in more detail herein in terms of an exemplary enterprise context, and typically in the context of a financial enterprise. This is for convenience only and is not intended to limit the application of the present invention. In fact, after reading the following description, it will be apparent to one skilled in the relevant art(s) how to implement the following invention in alternative embodiments, as indicated above. Thus, the description provided below is for purposes of illustration and explanation only, and should not be construed as limiting the scope of the invention. Rather, the scope of the invention is determined by the appended claims.

### II. Terminology

The terms “business”, “institution”, “organization”, “consumer”, “customer”, “client”, “prospect”, and/or the plural form of these terms are used interchangeably throughout herein to refer to those entities capable of accessing, using, being affected by, and/or benefiting from the products and/or services of the representative enterprise which would implement and apply the present system and method for linking business customer account information.

Furthermore, the terms “business”, “institution”, “merchant”, and/or “organization”, may be used interchangeably with each other and shall mean any person, entity, distributor system, software and/or hardware that is a provider, broker and/or any other entity in the distribution chain of goods or services. For example, a business may be a grocery store, a retail store, a travel agency, a service provider, an on-line merchant, a financial institution or service provider, or the like. A business or organization as understood herein may include not only for-profit businesses, but also non-profit or not-for-profit organizations such as schools, and may even be construed to encompass governmental or semi-governmental agencies, including but not limited to the Post Office, law enforcement agencies, etc.

As the present invention relates to a business which, among other activities, manages a list or a database of other businesses or institutions, some ambiguity may arise from the frequent use of the term “business”.

Therefore, for purposes of this document the term “enterprise” will be used to refer specifically and exclusively to a business or other organization which implements the present invention to manage a database of other businesses, institutions, or organizations. All other references to “business” or “businesses” may be presumed to refer to companies, institutions, and other organizations, apart from the enterprise, for whom the enterprise may maintain one or more accounts, with whom the enterprise may have business relations, with whom the enterprise may seek business relationships, regarding whom the enterprise may seek or obtain institutional data, or which the enterprise tracks as part of a business-related database. No other special meaning, implication, or limitation should be drawn from the use of the term “enterprise”, except for its deliberate use as a means to distinguish a first business or institution which implements the present invention from all other businesses or institutions which are listed and tracked in a database or similar listing of the enterprise.

It is to be understood, then, that the enterprise in question has customers which may typically be business customers or other organizational or institutional customers. Throughout much of this document the term “business” or “business customer” will be used, it being understood that this is a way of referring in brief to business, institutional, organizational, and/or other customers of the enterprise.

An “account” may be understood to refer broadly to a collection of data which an enterprise may maintain in relation to a business customer associated with the enterprise. In particular, however, an account may constitute both a set of data which identifies the customer (such as business name, contact name(s), address information, phone number(s), identifying numbers, etc.), and further to an associated set or collection of data which indicates transactions between the enterprise and the business customer. These transactions may be bundled together under the name of a service of some kind, and/or a status or statuses of services which the enterprise may provide to the customer, and/or a set of one or more legal or financial obligations on the part of the enterprise towards the customer, and/or a set of one or more legal or financial obligations on the part of the customer towards the enterprise.

For example, a loan account may record a business customer's credit line with an enterprise, as well as specific transactions wherein the customer has borrowed money against the loan account or paid back principle or interest on the account. A specific type of loan account may be a credit card account or other lending vehicle. An account may be an account of an entire business, or of a business unit within a business, or it may be an account associated with a particular individual functioning within their capacity as an employee, executive, or other person associated with the business.

An “account number”, as used herein, and as sometimes also referred to simply as an “account”, may include any device, code, number, letter, symbol, digital certificate, smart chip, digital signal, analog signal, biometric or other identifier/indicia suitably configured to allow a business or institutional customer to access, interact with or communicate with a financial transaction system or other transaction system of an enterprise. The account number may optionally be located on or associated with any financial transaction instrument (e.g., rewards, charge, credit, debit, prepaid, telephone, embossed, smart, magnetic stripe, bar code, transponder or radio frequency card). An account number may also refer to a similar identification value (e.g., a device, code, number, letter, symbol, digital certificate, smart chip, digital signal, analog signal, biometric or other identifier/indicia) which is used by an enterprise as a means to identify a customer for purposes of in-house processing.

A customer account number may be, for example, a sixteen-digit credit card number. Each credit card issuer has its own numbering system, such as the fifteen-digit numbering system used by American Express Company of New York, N.Y. A merchant account number may be, for example, any number or alpha-numeric characters that identifies a particular merchant for purposes of card acceptance, account reconciliation, reporting and the like.

A customer account may be associated with a record in a database or other storage. In this document, such terms as “customer account”, “customer record”, “business account”, “business record”, and similar terms and the plurals thereof will be used interchangeably to designate a storage of account data pertaining to a business or other customer.

A “generation code”, sometimes called a “suffix”, is a suffix to a name, which may be a full word such as “Senior” or “Junior” or similar, or an abbreviated word such as “Sr.”, or “Jr.” or similar, or may be a numeric word, number, or phrasing such as “the Second”, “the Third”, “2^{nd}”, “3^{rd}”, or similar, which indicates lineage within a family, and is generally considered to be part of a person's full name.

### III. iCLIC Method

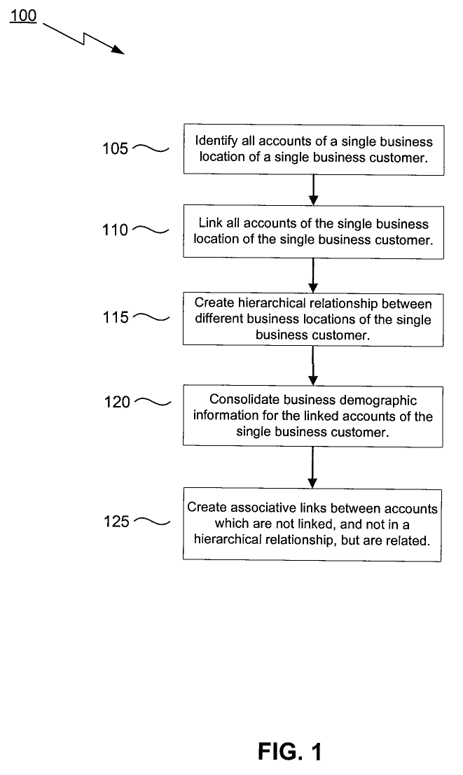

FIG. 1 is a flowchart illustrating an exemplary iCLIC method 100 according to an embodiment of the present invention.

Step 105 entails identifying a plurality of accounts of a single business customer at a single location of the single business customer. For example one, or more account databases of the enterprise may be searched to identify business records which are associated with the single business location.

In step 110 the plurality of accounts which have been identified in step 105 as being associated with a single business location of a single business customer may be linked to each other. The linkage is accomplished, for example, by assigning to such accounts a shared or common identification value. This identification value may be unique within the database to these linked accounts, and may be a persistent ID value in the sense that in the normal course of operations it will not typically be changed over time. The exact nature of this unique, persistent ID value, which may be a number, an alphanumeric designation, or some similar identifier, may vary according to different embodiments of the present invention.

Steps 105 and 110 may be repeated for each unique location of each business customer within the enterprise database, such that for each unique location of each business customer, a plurality of the business accounts associated with a particular business location of a given particular business customer may be linked to each other. The result is an enterprise database which, for a plurality of business customers in the database, correctly reflects and indicates a plurality of the accounts that are associated with each unique location for each customer of the plurality of business customers.

Step 115 entails creating a hierarchical relationship between different business locations of the single business customer. As with steps 105 and 110, step 115 is repeated for each business customer of the enterprise. As a result, the database comes to include not just a database of separate accounts, but instead a database where a plurality of accounts for each business may be linked to each other, either directly linked through a shared common identifier if the accounts are accounts of a single location, or accounts linked in a hierarchical relationship which reflects the business structure for each business. More will be said below about the nature of the hierarchical relationships between the accounts of a single business.

As will be discussed further below, the preceding steps entail gathering business information for each account within the database. The information gathered includes, for example and without limitation, information on employees of the business, sales information, various incorporation and other legal information pertaining to the business, business ownership, and numerous other elements of information pertaining to the operations and structure of the business. Such information is collectively referred to as “business demographics” (again, sometimes referred to in the art as “firmographics”).

Step 120 entails consolidating the business demographic information for any business, which may be done either on a location-by-location basis, or on a firm-wide basis, or both. Step 120 may further entail determining whether there are certain kinds of desired business information which were not gathered in the preceding steps, and then searching either through internal databases or external databases, or both, in order to obtain the desired business demographic information. Such additional information, if any, is then applied to (e.g., associated with) the linked and hierarchical business accounts of the business, as established in the preceding steps.

Finally step 125 entails creating associative links. In some cases there may exist accounts which are accounts of separate businesses, and are therefore not linked to each other and are not in a hierarchical relationship to each other, and yet where such accounts still share some kind of relationship to each other. To name just one example, two such accounts may in fact be accounts of the same person, wherein the person is employed by or has relations with two different businesses and therefore enjoys accounts with two different businesses. Such accounts may be associated with each other in order to reflect that the accounts may have common aspects of management or maintenance. For example, two such accounts which are otherwise not linked and not in a hierarchical relationship, but which are associated with the same person, may share common marketing profiles.

Linking Accounts Using iCLIC

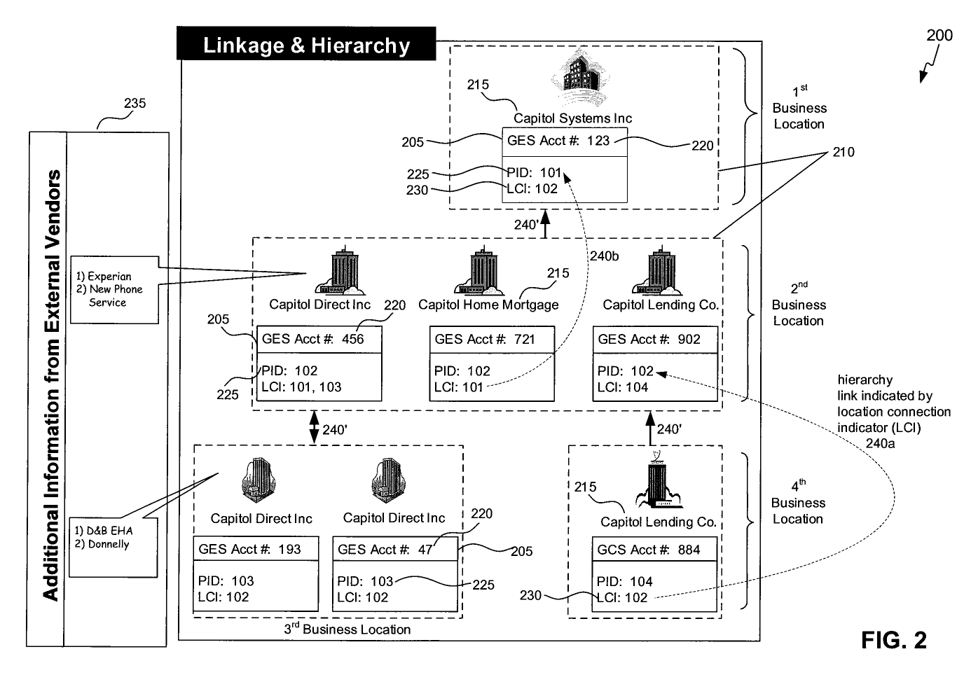

FIG. 2 illustrates exemplary linkage and hierarchy relationships established between accounts for a single business in accordance with steps 105, 110, and 115 of exemplary method 100. Illustrated are multiple accounts 205 associated with various business locations 210 of a single business, where such accounts may be stored in one or more databases of the enterprise. Such accounts may be, for example and without limitation, accounts of different business units within the single business, or business-related accounts of individual employees or executives of the business. Although they may all be accounts of a single business, they may be associated with different business names 215 associated with various business units or business entities of the one overall business. As is typical of most accounts, each account has a distinctive account number 220, which may be associated with different types of accounts, such as for example merchant (GES) accounts or corporate (GCS) accounts of American Express Co. of New York, N.Y.

As a result of, for example, method 100, a plurality of accounts of a common location are assigned a common, unique, persistent ID (PID), here illustrated as exemplary persistent IDs (PIDs) 225. In addition, different locations within the common business may be linked to each other in a hierarchical fashion (e.g., a local franchise may be linked to a corporate headquarters in a hierarchical fashion). In an embodiment of the present invention, each account may be assigned one or more location connection identifiers (LCIs) 230, which indicate that each account is linked to accounts at one or more other location(s) according to the PID(s) 225 associated with those other location(s). That is, the value assigned to an LCI field or LCI element of an account data record may serve as a reference to or pointer to the PID value of another, second location; this may indicate that the location associated with the account is in a hierarchical relationship with the second location.

In one embodiment of the present invention, the location connection identifiers may simply indicate business sites associated with other locations of the same business. In an alternative embodiment, the location connection identifiers or additional data associated with the location connection identifiers may indicate a hierarchical nature of the linkages, wherein some business sites may be subordinate to other business sites, while some business sites occupy an executive capacity or other relationship of higher ranking in relationship to other business sites.

In the exemplary account linking and hierarchy 200, accounts 205 associated with a particular business location may be assigned a common PID 225 value, where the exemplary PID value “102” is illustrated in conjunction with the site labeled as the “2^{nd} Business Location”. One of these accounts with PID value “102”, namely the account of “Capitol Direct Inc.”, is also hierarchically linked with accounts “123” and “193” at other locations via exemplary LCI 230 values “101” and “103”. These latter values (that is, “101” and “103”) reflect the PID 225 values of accounts at the other locations.

The identification of accounts in accordance with, for example, step 105 in method 100, is a non-trivial matter, for reasons including but not limited to the fact that addresses are not always recorded consistently, different addresses may exist for a single location, a plurality of business names or business entities may exist for a single business, and for other reasons.

Step 105 may entail, for example, applying a plurality of account comparison and matching rules to a plurality of account data, wherein a first account of a single location of a particular business customer is matched to a second account at the same location of the same business customer. These business comparison and matching rules apply a variety of algorithms to the existing business data, including, for example and without limitation, matching business name data, account holder name data (for accounts associated with an individual within a business), business address data, business ID numbers (such as DUNS numbers), and other types of data identified in further detail below.

The account data may be obtained from already existing, in-house databases of the enterprise which maintains the database. Account data may also be obtained by referencing outside sources of data 235 which can be used to help find linkages among existing, in-house business account data. These external data sources 235 may include business, government, and other databases which are external to the enterprise. Such external sources may include, for example and without limitation, databases provided by Dun & Bradstreet of Short Hills, N.J., Donnelley Marketing of Woodcliff Lake, N.J., American Business Institute of Richmond, Calif., and numerous other business data sources well known in the art.

Obtaining account data from external data sources 235 may include both obtaining additional or updated data for businesses which are already included in existing, in-house databases of the enterprise; and also obtaining data for businesses which are not already included in existing, in-house databases of the enterprise. The latter data (that is, data pertaining to businesses not already listed in in-house databases) may include data for businesses which are marketing prospects and/or potential marketing prospects of the enterprise. Information obtained from external data sources 235 pertaining to marketing prospects and/or potential marketing prospects of the enterprise may include business location information and other information for which matching and linking rules may be applied, as discussed in more detail immediately below.

Obtaining information about a larger population of businesses beyond the current customers of the enterprise, including in particular marketing prospects and/or potential marketing prospects, may be referred to as obtaining information on a universe of businesses. By obtaining information on a universe of businesses, it may possible to increase the likelihood of successfully linking and associating businesses in the database(s) of the enterprise. In addition, by obtaining information on a universe of businesses, as the enterprise acquires new business customers it may be possible for the enterprise to immediately link or quickly link new customer accounts with businesses already identified as part of a universe. In addition, by obtaining information on a universe of businesses, as the enterprise acquires new business customers it may be possible to immediately or quickly provide appropriate business profile information for such purposes as marketing and support.

The types of data which may be obtained for a business account and for which matching and linking rules may be applied include, for example and without limitation, business names, business owner identifications, business executive identifications, business staff person identifications, business addresses, business phone numbers, business types, business services, business products, business communication channels, business financial data, business market data, American Business Institute (ABI) identification values, business identification values (BINs) assigned by Acxiom, DUNS number assigned by Dun & Bradstreet, executive home addresses provided by Dun & Bradstreet, Execureach business record files which may be obtained from Donnelley Marketing, National Business Database (NBD) data provided by Experian Group Ltd. of Costa Mesa, Calif., Federal Employee Identification values (FEIN), other identification values well-known in the art, any commercially available data about businesses, government supplied data about businesses, business data available from phone directories, business data available from various sources of business news, and data about businesses which may be stored in an historical file of business prospects.

Exemplary methods, rules, and algorithms for matching and linking accounts based on the types of business data and similar types of business data may be found in U.S. patent application Ser. No. 11/677,906, filed Feb. 22, 2007, and Ser. No. 11/529,604, filed Sep. 29, 2006, which are incorporated herein by reference in their entirety. Matching and linking accounts may include in particular several specific steps and/or processes designed to increase the probability of correctly identifying accounts of a common business, and of identifying accounts of a single location of a common business. These steps and/or processes may include, for example and without limitation:
Cleansing the initial account data, which may entail removing extraneous identification data from the account data (for example, removing unnecessary identification numbers), identifying typographical errors, identifying invalid truncations, and identifying other invalid information;
Standardizing name formats, address formats, and other data formats (for example, shortening middle names of persons to middle initials, standardizing zip code formats, standardizing phone number formats, standardizing “Street” to “St.” or vice-versa, “Court” to “Ct.” or vice-versa, etc.);
Identifying multiple addresses for a single account (for example, an applicable post office box address along with a standard street address);
Updating account data to reflect business mergers, business acquisitions, and business divestitures (so that, for example, two business accounts which were formerly associated with separate businesses may now be recognized as being associated with a single business—and possibly a single location of the single business—due to one or more business acquisitions and/or mergers).

The matching and comparison rules may be customized by assigning a quality-of-match level for at least one account identification attribute among the available account identification attributes. Some exemplary customizations may include, for example and without limitation:
Two personal names may be considered a match even if a middle name or initial is present for one, and not present for the other.
Two phone numbers, two street address numbers, or two values of other corresponding data fields from a respective two accounts records might be considered a match even if there is a single digit which is different, based on the possibility that a single digit of one of the phone numbers, street addresses, or other data fields might have been recorded erroneously. Since data errors can occur in account databases, and since a match or linkage between two account records is typically based on a match of a plurality of account identification attributes, permitting a limited degree of flexibility in matching attribute values from two different accounts may actually result in an increased likelihood of correct matching and linkages between accounts.

Multiple passes may be made on the data to maximize match rates. For example, on a first pass through the data, a first account record A may fail to be identified as being an account of the same business and at the same location as a second account record B. However, on the same first pass through the account data, account record A may be correctly identified as being an account of the same business and the same location as a third account C. Also, on the first pass, second account record B and third account record C may be correctly identified as being accounts of the same business and the same location. As a result, on a second pass through the data, and due to the now-established association of A to C and also B to C, account A and account B may be correctly identified as being accounts of the same business and the same location.

The application of matching and comparison rules, and/or the application of data from specific databases may be customized depending on the types of accounts being matched. For example, an enterprise such as a financial institution may have a first type of account for credit cards provided to small businesses, a second type of account for credit cards provided to cardholders at large businesses, and a third type of account for merchants who collect payments via credit cards of the enterprise. Different types of matching rules and/or linking rules may be applied to the different types of accounts.

For example, for credit card accounts associated with large corporations (i.e., the second type of account indicated immediately above), it may prove impossible in some cases to identify a specific location for some accounts. In these cases, the default rule may be to assign such accounts to the location associated with the headquarters of the entire business. Such a rule may not, however, be deemed applicable to apply to credit card accounts for small businesses (the first type of account) or merchant accounts (the third type of account).

For a second example, two types of business databases may be employed, one for businesses which are currently in business (an “active universe” database), and one for businesses which are currently in business or have ceased being in business (a “full universe” database). For some types of business accounts it may be deemed appropriate to apply the business comparison and matching rules against the full universe database, while for other types of business accounts it may be deemed appropriate to apply the business comparison and matching rules only against the active universe database.

### Business Hierarchies

Step 115 of method 100 entails creating hierarchical relationships between different business locations of a given, single business customer. FIG. 2, already discussed above, illustrates how accounts associated with different locations of a business may be linked in a hierarchical fashion. The linkages between locations may, for example, be established by associating with each account one or more LCIs (the previously discussed “location connection identifiers”). An LCI data element within an account record may contain a reference to a PID value (“persistent ID” value) of another location. For example, in FIG. 2, GCS account # 884, associated with the 4^{th} business location, has an LCI value of “102”. This LCI value references the PID value of “102” associated with the 2^{nd} business location.

In this way may be established exemplary hierarchy relationship 240a (illustrated via the curved, dashed connecting line), which may indicate that the 4^{th} business location is hierarchically related to the 2^{nd} business location. Another exemplary hierarchy relationship 240b is also illustrated via a curved, dashed connecting line. While these hierarchical relationships 240 may be flagged or indicated via data elements (the LCIs which point or refer to PID values) within the account data, they may also reflect hierarchical relationships 240′ that exist between the business locations themselves.

Exemplary methods, rules, and algorithms for establishing hierarchical relations between accounts based on business data may be found in U.S. patent application Ser. No. 11/677,906, filed Feb. 22, 2007, which is incorporated herein by reference in its entirety.

While the exemplary hierarchical relationship illustrated in FIG. 2 identifies only a single hierarchy among the multiple business locations, an alternative embodiment of the present invention may identify and flag, through appropriate linkages, two or more types of hierarchical relationships between business locations. For example, a business may have legal hierarchy, which pertains to the ownership of business units at different locations, and even to business units within a single location (for example, parent vs. subsidiary relations); while the same business may also have a management hierarchy, pertaining to an operating view of the business (e.g., headquarters vs. branches).

Several specific steps, algorithms, and/or methods may be designed to increase the probability of correctly identifying hierarchical relations between accounts of a common business customer, wherein those accounts may be associated with different locations of the business customer. These steps, algorithms, and/or methods may include, for example and without limitation:
Creating a hierarchical relationship based on the organizational structure of the business customer. Information on the organizational structure of a business customer may be obtained from numerous sources. Existing account information of the enterprise may already reflect which accounts may be associated with executives of the business, which accounts may be associated with the headquarters of the business and which accounts may be associated with satellite locations, and which accounts may be associated with franchises, retail outlets, distribution centers, and other subsidiary locations. A set of hierarchy rules may indicate a preferred or preliminary set of relations, for example that the business headquarters (and accounts associated with the headquarters) are always at the top of the hierarchy, that distribution centers may outrank retail outlets, etc.
Hierarchy rules may also be based on other indicators. For example, business locations which contain in their description certain keywords, such as “corporation” or “incorporated” may be flagged as outranking associated business locations which lack such keywords. For example, a business location identified as “Flagstaff Foods Corporation” may be assigned a higher place in a business hierarchy than other business locations identified as “Flagstaff Fine Eateries”. As another example, a business location name which is unique to a business may be ranked as being higher than other business locations of the same business which share the same name. For example, a single “Flagstaff Foods Corporation” may then outrank multiple “Flagstaff Fine Eateries.”
Hierarchy-related information may also be obtained from various third-party sources of business information already referred to above, such as Dun & Bradstreet of Short Hills, N.J., Donnelley Marketing of Woodcliff Lake, N.J., American Business Institute of Richmond, Calif., and numerous other business data sources well known in the art. Additional sources of data may include incorporation records and other publicly available legal records available from various legal databases, which may pertain to the ownership of the business and various subsidiary business units. Where multiple sources of hierarchy information may conflict, rules may be instituted to prioritize among the hierarchy data.
Hierarchical relationships among different locations of a common business may be based on financial transactions of the business accounts. In particular, transactions of multiple locations with a common business institution or common business structure may be used to identify hierarchical relations, and may be further employed to link businesses that were previously not linked.

For example, a financial enterprise, such as a credit card issuer, employing the method of the present invention, may be able to identify multiple business locations for apparently different merchants, but where all the merchants deposit their credit card collections to the same bank account of a common bank. This may indicate that all these merchants may be merchants of a common business. Moreover, both the value of the deposits and the discount rate applied to the credit transactions may be indicators of the size of the merchants, and hence an indicator of hierarchical relationships. In addition, if an apparently second group of merchants is identified as having an identical payment hierarchy in relation to a second bank, this may indicate that the first set of merchants may actually be the same businesses as the apparently second set of merchants.

Similarly, if a payment hierarchy along the lines just described is found to be identical in structure to an organizational hierarchy identified through a third-party source (such as Dun & Bradstreet), a rule may determine a likelihood that the two business hierarchies may in fact be hierarchies of the same business.

### Business Demographics

As already indicated above regarding step 120 of method 100, a wide variety of data about a business is inherently contained in the available account data which an enterprise stores pertaining to a business. Moreover, extensive additional data is available via the external third-party sources already discussed (i.e., Dun & Bradstreet, Donnelley Marketing, American Business Institute, etc.), and this data can be obtained in the course of the processing (i.e., the account comparison, matching, and linking) already described above. Available information includes, for example and without limitation, business demographics, the number of years a business has been in operation, associated industry codes and industry codes with extensions, names of executives, sales volume, business revenue, gross profits, employee counts, and similar information.

However, it is an advantage of the present invention that by accurately identifying and linking a plurality of accounts associated with a business location for each of a plurality of locations of the business, it is possible to consolidate the business demographic data, to summarize the business demographic data, and to provide a variety of slices or cross-sectional views of the business demographic data across different levels and/or subunits of the overall business. A further advantage of the present invention may be that by identifying addresses associated with a business, it may be possible to search for businesses or accounts by a business address, in addition to or as an alternative to searching based on account numbers or business names. For example, a user interface employed by a sales representative or customer support representative of the enterprise may be able to effectively search for customers and/or prospects based on address information, in addition to or as an alternative to searching based on account numbers or business names.

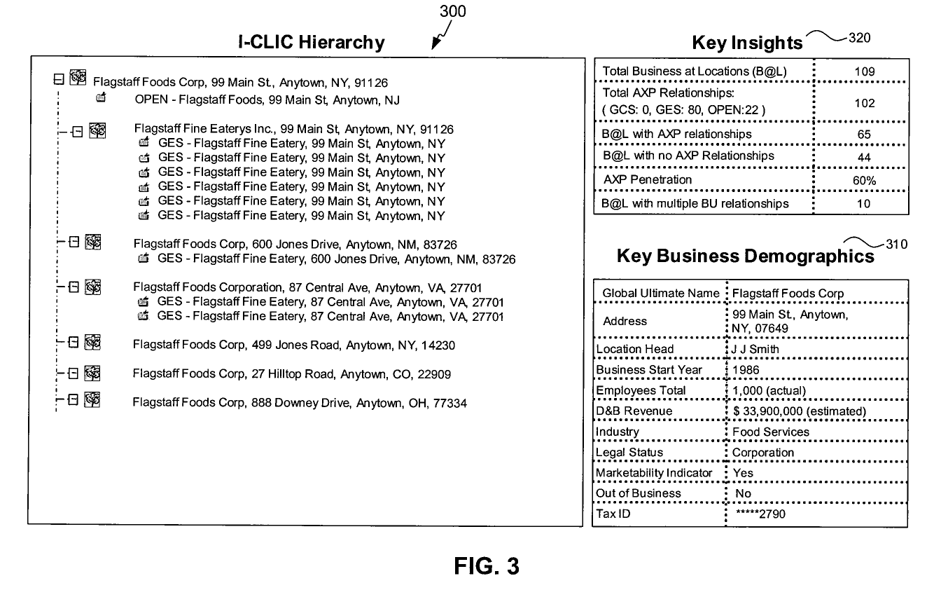

FIG. 3 illustrates an exemplary iCLIC hierarchy 300 for a particular business, Flagstaff Foods Corporation. Associated with the hierarchy are general business demographics 310 (labeled as “Key Business Demographics”) for the business as a whole. However, in addition to simply consolidating the data, an insight-oriented assessment of the business data is enabled, as shown under the heading “Key Insights” 320. For each business location of the business, a plurality of accounts associated with the location of the business may have been identified. In some cases, all or substantially all accounts associated with the location may have been identified. Therefore, by correlating account data with business locations, it is possible to further identify such factors as the total business at locations (“B@L”), total relationships for different types of accounts (e.g., small business accounts for branches or franchises, corporate accounts, and merchant accounts), total number of business locations with relationships to the enterprise, total number of business locations without relationships to the enterprise, locations with multiple business relationships (i.e., multiple accounts) with the enterprise, etc.

Persons skilled in the relevant arts will readily recognize that it would be further possible to characterize the relationships of the business to the enterprise in correlation with other pertinent factors, for example, by city, by state, by size of the business locations, etc.

The business demographic information may be updated on a periodic basis. In one embodiment of the present invention, business demographic information may be updated on a partial and/or sporadic basis, as the data processing associated with account linking is updated from time-to-time, and as associated business demographic information is updated as part of the process. In an alternative embodiment, comprehensive business demographic information may be updated on a scheduled or on-demand basis, where the update may entail obtaining, integrating, analyzing, and correlating business data which may not necessarily be needed for immediate purposes of account linking.

### Associative Linking

Step 125 of method 100 entails creating associative links. In some cases there may exist accounts which may be accounts of separate businesses, and are therefore not linked to each other and are not in a hierarchical relationship to each other, and yet where such accounts still share some kind of relationship to each other. A first account and a second account may be linked associatively according to associative linking rules, where such associative linking rules may be based on criteria which may include, for example and without limitation:
determining that the first account and the second account are accounts of a common person;
determining that the first account and the second account are accounts sharing a common business interest (for example, they may be accounts which share usage of a common bank account, or which jointly participate in ownership of some asset);
determining that the first account and the second account are accounts sharing a common demographic (for example, the two accounts may share a common location or mailing address);
determining that the first account and the second account are accounts of a respective first business and second business, where the first business and the second business in turn share some business association (for example, they may be commonly owned businesses, businesses where one business was a spin-off of the other business, or businesses which are otherwise associated);
determining that the first account and the second account are accounts of particular separate business units of some particular, common business, where a deliberate decision has been made (e.g., a rule has been established) to not link accounts between those particular separate business units of that particular business; and/or
determining that the first account and the second account are accounts of a respective first person and second person, where the respective first and second persons are associated through common business dealings, family relationships, work relationships, or in some other way.

It will be apparent to persons skilled in the relevant art(s) that linking and matching rules operating in a manner at least partially analogous to the rules described above may be implemented to establish the kinds of associative relationships indicated. An enterprise may take advantage of proprietary, in-house data (sometimes referred to as “closed loop data”) to establish relationships between people or businesses, and hence between accounts, which may not be readily apparent based on publicly available data. For example, in-house data may reveal that two accounts share common ownership of some business asset, or access a common bank account, or are owned by respective partners of a married couple (who may in turn be identified via private financial account data of the enterprise).

Similarly, persons skilled in the relevant art(s) will recognize that a variety of data linking mechanisms, such as a specialized associative linking field or other associative linking data structure, may be employed within account records to indicate an associative link between a first account and other accounts.

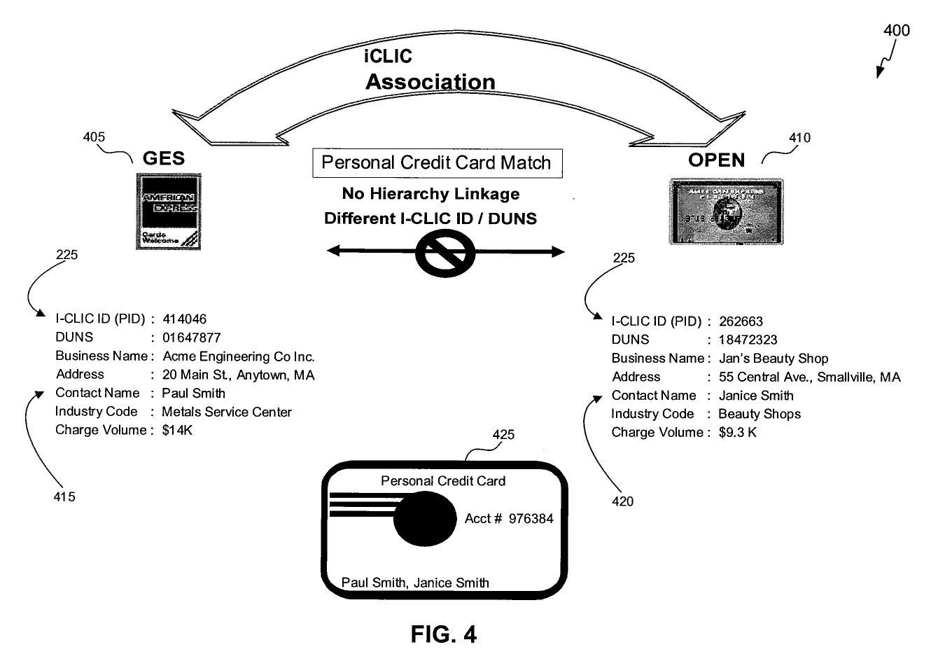

FIG. 4 illustrates an exemplary associative linking 400 of two accounts according to an embodiment of the present invention. First account 405 is a merchant account of a first business, Acme Engineering Company, while second account 410 is a credit card account of a second company Jan's Beauty Shop. The two businesses are not associated, and do not share any significant information suggesting a linkage between the two accounts, other than the fact that the account contact names share a last name “Smith” (Paul Smith 415 and Janice Smith 420). However, an analysis of personal credit card record 425, which is maintained by the same enterprise which maintains the two business accounts 405, 410, reveals that Paul Smith 415 and Janice Smith 420 share common ownership of credit card 425. (Further account data may indicate that Paul Smith 415 and Janice Smith 420 are married or share some other relationship viewed as a basis for associative linking.) Based on the associative linking rules, an associative link is then established between the two business accounts 405, 410.

### IV. Error Checking and Self-Correction

A variety of mechanisms may be employed for purposes of error checking and self-correction. Error checking may entail, for example, identifying different classes of errors, including proprietary linkages (that is, linkages which may be meaningful in certain specialized contexts, but which are not appropriate within the overall context), errors in external data, questionable linkages, data anomalies, and matching and comparison rules which are in some respect flawed. Self-correction mechanisms may entail identifying the sources of errors and modifying either data or linking rules to prevent the same errors (or similar errors) from occurring in the future.

In more detail, possible errors which may be detected may include, for example and without limitation:
errors in account linkages;
errors in the structure or format of data, which may include both internal data (that is, data stored by the enterprise regarding business customers of the enterprise) and data from external data sources;
errors in the content of data (including both internal data and/or external data) which may be introduced as a consequence of erroneous data collection; incomplete data collection; data which has been rendered obsolete as a result of changes in the business world (for example, mergers, acquisitions, companies going out of business, companies changing names, etc.); and, in some instances, erroneous data which has been supplied for deliberately fraudulent purposes;
errors in the rules, where such errors may include, for example and without limitation, rules which should not be used at all, rules in need of modification, rules which should be applied to data sets other than those to which they are currently applied, and rules which are needed but are not yet implemented.

### Structural Data Errors

One exemplary method to identify data errors is to examine hierarchical views of a business for errors. Two or more hierarchical views of a business may be constructed, with each hierarchical view based on different hierarchy criteria. For example, and as previously discussed, one hierarchical view of a business may be constructed based on criteria pertaining to in-house (that is, enterprise-maintained) data, such as business financial data maintained by a financial enterprise. A second hierarchical view of the same business may be constructed based on externally obtained data, which may be based on different criteria, such as a legal view of the business or a management structure view of the business.

Once two different hierarchical views of the same business have been constructed, the two different hierarchies may be compared to see if there are inconsistencies. For example, a hierarchical view based on in-house data may indicate a certain number of locations associated with the business, while the second hierarchical view based on external data may indicate a different, possibly smaller number of locations associated with the same business. Once such an anomaly has been identified and flagged, it is possible to investigate the source of the anomaly.

For example, it may be the case that erroneous in-house data indicates more locations for the business than actually exist. This, in turn, may be due to redundant business data collection in different business units of the enterprise (possibly along with the use of different addresses for a single business location), or it may be due to a business which deliberately and fraudulently has reported business locations or business activities which do not actually exist. Another possible cause of the data discrepancy may be that the externally obtained data is actually erroneous, in which case the issue may need to be resolved with an external vendor of business data. It may also be that the linking and hierarchy rules have a systematic error, or a particular rule which is problematic, and which is in need of identification. This is discussed further immediately below.

### Feedback Loops

As indicated above, data anomalies, such as a discrepancy between two different hierarchical views of a business, may be used to flag, determine, and rectify sources of errors in the linking and hierarchy-establishing process. Possible sources of data anomalies may include, for example and without limitation, flawed linking rules, misapplication of a linking rule, flawed hierarchy rules, a misapplication of a hierarchy rule, a lack of a linking rule or hierarchy rule which is needed to improve the linking capability, data errors in external data sources, and data errors in internal data sources.

One exemplary method to check for errors is to apply one or more feedback loops. In one embodiment of the present invention, one or more of the feedback loops may involve some intervention of a human operator. In an alternative embodiment, all feedback loops may be entirely automated.

In one embodiment of the present invention, a feedback loop may employ a human auditor as part of the feedback process. For example, a human auditor may be employed to ensure that all accounts which have been identified as being associated with a single location of a common business are, in fact, associated with a common address and a single business entity. If an erroneous linkage is found (i.e., a case where two linked accounts are discovered to actually belong to completely separate business entities, or separate addresses), then the feedback system may further identify which rules indicated that the two accounts should be linked; these rules can then be flagged as being potentially problematic, and can be further reviewed or evaluated by programmers, business analysts, systems analysts, etc. The process of identifying problematic linkage rules may be partly performed by human programmers or analysts, and may also be partly supported by automated methods for tracing a linkage back to specific rules which resulted in the linkage.

In another embodiment, feedback loops used to identify problematic results, and the sources of the results, may be entirely automated. Such automated feedback loops may rely in part or in whole on data inconsistencies to flag potentially problematic results. For example, it is possible to employ systematic checks of whether or not output data is reasonable in order to identify data anomalies.

In one embodiment of the present invention, an automated error-flagging system may determine the number of employees in a business by adding the number of employees in each separate business location of the business. This number of employees, within some selected degree of accuracy, should be substantially the same as the number of employees reported by various business data sources for the total number of employees in the business. If there is a significant discrepancy between these two values for the number of employees, this may indicate errors with the linking process, the hierarchy-establishing process, or with various data sources. Certainly, some specific errors can be readily flagged, for example, a single location of a business that reports more employees than the entire business.

Persons skilled in the relevant art(s) will also recognize that other such data discrepancy flags can be implemented pertaining to discrepancies between a single business location and entire business hierarchy, or between aggregate values for a business hierarchy compared to values reported for the entire business. Such discrepancies may pertain to such matters as business sales, revenue amounts, and related numeric data.

In an alternative to the automated error-flagging system, the linking capability may be run repeatedly, using newly acquired data and also using linking rules and hierarchy rules which have been modified over time. Sudden changes in output performance may be indicators of errors. For example, a dramatic increase or decrease in the number of unmatched business records may indicate potential problems.

Persons skilled in the relevant arts will recognize that various automated means may be implemented to trace specific output results back to specific rules and specific data. In this way the rules and the data may be evaluated as possible sources of error.

The self-correction aspect of a feedback loop occurs when the source of an error is rectified. Appropriate corrections may be determined on a case-by-case basis, but may include, for example and without limitation, adding a new linking rule, modifying a linking rule, deleting a linking rule, adding a hierarchy rule, modifying a hierarchy rule, deleting a hierarchy rule, changing the application of a linking rule, changing the application of a hierarchy rule, changing a parameter of a linking rule, changing a parameter of a hierarchy rule, correcting an error in the external data, and correcting an error in the internal data.

In some cases, more than one correction may be possible, and a choice of possible corrections may need to be determined by a programmer, systems analyst, or other analyst.

As an exemplary instance of identifying an error and correcting it, it may occur that a number of business account records are linked because the business names share a common element of text, wherein the common element is in fact not really part of the business name, but rather a flag or signifier used by some other enterprise process. For example, an account management process of the enterprise (that is, a process apart from the linking capability) may add common elements of text to business names of various accounts, such as “BTA” for “business travel account”, “BPA” for business purchase account, “BSA” for business supplier account, etc. As a result, there may be some erroneous linkages among accounts where the text “BTA”, has been added to the business names, and also erroneous linkages among accounts where the text “BPA” has been added to the business names, etc.

In this exemplary case, more than one solution may be implemented as part of the feedback process. For example, a rule may be added to strip the common text elements (e.g., “BTA”, “BPA”, “BSA”) from the account data when the accounts are imported into a computer process which implements the linking capability. Alternatively, the common text elements may be retained as part of the names, but a rule may be implemented indicating that the same common text elements may be ignored when processing business names for possible matches.

Feedback from the iCLIC process can also be returned to a business unit that is responsible for the input data so that demographic corrections to data elements may be accepted, and further so that additional rules may be added, or existing rules may be modified, to enable and enhance future corrections to data elements. For example, Dun & Bradstreet data may be fed back to the business unit to correct data elements which may include, for example and without limitation, the business name, telephone, address, and owner. Based on the revised data fed in through the feedback loop, the business unit may determine a need for additional business rules, or a manner in which to modify existing business rules, in order to re-match existing data against external sources or to identify existing types of data which may not find a match during the iCLIC process.

### System Error and Performance Reporting—A Dashboard View

A further aspect of the feedback system may include implementing a user-interface for presenting, to human operators and analysis, a view of the overall process output and/or a view of possible errors detected during the auditing process. Such a user interface may be in the form of one or more printed reports, one or more reports shown on a display screen, one or more reports stored in a file, or other forms of reporting well known in the art. Such a user-interface, which may be referred to as a “dashboard” (in analogy to an automotive dashboard, which displays key aspects of automotive performance) may provide human operators with either or both of a high-level view of process results and/or errors, and also a means to drill down to more specific results of the process.

Information presented via a dashboard may include, for example and without limitation, one or more metrics of the quality of the data input into the present system, one or more metrics of the quality of the data output of the present system, results of the application of specific linking rules, and results of the application of specific hierarchy rules. Particular information may include, for example and without limitation, numbers and/or percentages of account records with incomplete data (which may be further categorized according to the kinds of incomplete data); numbers and/or percentages of account records with erroneous data; and numbers of percentages of accounts/records reflecting businesses which either never existed, are now out of business, or have been absorbed by or merged with other businesses. A dashboard may also categorize the linkages according to a percentage level of confidence (indicating, for example, the X % of the linkages are considered Y % reliable, while Z % of the linkages are considered to be Z % reliable, etc.).

Information presented via a dashboard may further be broken down or consolidated into specific categories. For example, data quality for business records and business data may be presented on a per-database basis, reflecting data quality in different in-house databases of the enterprise; on a per-enterprises-business-unit basis, reflecting the data quality of data maintained by different in-house business units of the enterprise; or on a per vendor basis, reflecting the quality of data from different vendors or other sources of external business data. Persons skilled in the relevant art(s) will recognize that other data quality reporting categories may be implemented as well.

A dashboard system may be implemented with “hypothesis testing” features as well. Such features may enable a systems analyst or other user to add a linking/hierarchy rule, suspend the action of a linking/hierarchy rule, or modify a linking/hierarchy rule (for example, by changing one or more parameters of a linking rule), and obtain immediate feedback on how such a change would affect the results of the linking and hierarchy process.

### V. Exemplary System

The present invention, as typically embodied in method 100, or as implemented in alternate embodiments as suggested throughout this detailed section and the appended claims, or any part(s) or function(s) thereof, may be implemented using hardware, software, and human operator decision making, or a combination thereof and may be implemented in part or in whole by one or more computer systems or other processing systems.

However, the manipulations performed by the present invention were often referred to in terms, such as adding, linking, or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general purpose digital computers or similar devices.

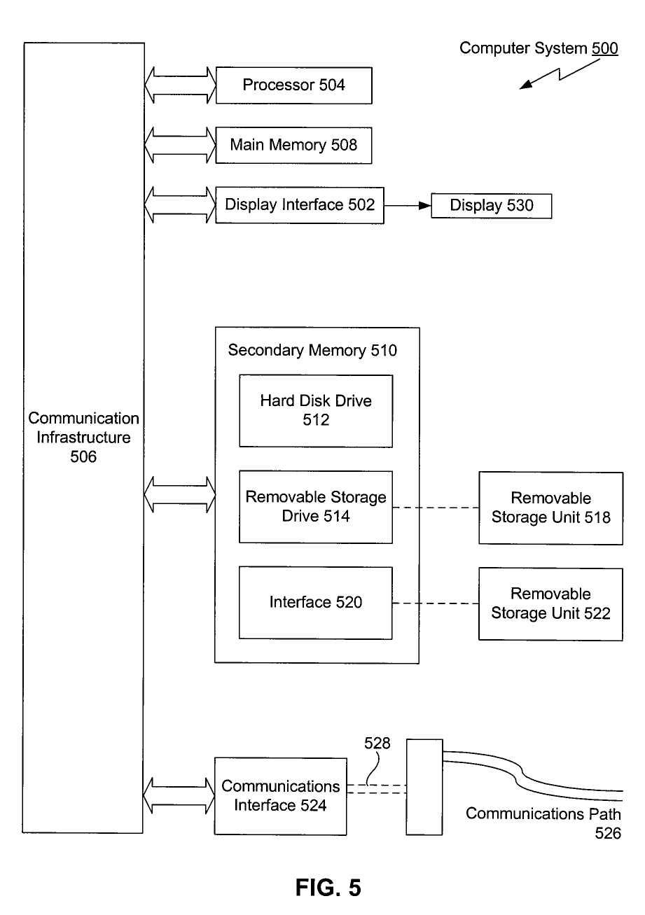

In one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may also include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528 which may be electronic, electromagnetic, optical or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 514, a hard disk installed in hard disk drive 512, and signals 528. These computer program products provide software to computer system 500. An embodiment of the invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### VI. CONCLUSION

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

1. A method of managing accounts stored by an enterprise, wherein said accounts are accounts of at least one business customer of a plurality of business customers of the enterprise, comprising:
identifying a plurality of accounts associated with a single location of the at least one business customer;
linking the plurality of accounts associated with the single location;
repeating said identifying and linking steps for a plurality of single locations of the at least one business customer, wherein a first identification and linkage is made to link a plurality of accounts of a first location of the at least one business customer and a second identification and linkage is made to link a plurality of accounts of a second location of the at least one business customer;
creating a hierarchical relationship between at least an account of the first location and at least an account of the second location; and
capturing business demographics for the linked accounts of the at least one business customer.

2. The method of claim 1, further comprising:
identifying a first account of the plurality of business customers of the enterprise and a second account of the plurality of business customers of the enterprise;
determining that the first account is not linked to the second account;
determining that the first account is not in a hierarchical relationship with the second account;
determining according to a plurality of association rules that an association exists between the first account and the second account; and
creating an associative link between the first account and the second account.

3. The method of claim 2, wherein determining according to a plurality of association rules that an association exists between the first account and the second account comprises at least one of:
determining that the first account and the second account are accounts of a common person;
determining that the first account and the second account are accounts sharing a common business interest;
determining that the first account and the second account are accounts sharing a common demographic;
determining that the first account and the second account are accounts of a respective first business and second business wherein the first business and the second business are at least one of commonly owned businesses or associated businesses;
determining that the first account and the second account are accounts of a respective first business unit and a respective second business unit of a common business, where a rule exists to not link accounts between the first business unit and the second business unit; and
determining that the first account and the second account are accounts of a respective first person and second person wherein the first person is associated with the second person through at least one of a common business dealing, a common business association, or a common personal association.

4. The method of claim 1, wherein linking the plurality of accounts associated with the single location comprises:
applying a plurality of matching rules to a plurality of account data, wherein a first account of the plurality of accounts of the single location is matched to a second account of the plurality of accounts of the single location; and
linking the first account with the second account by assigning a common identification value to the first account and the second account.

5. The method of claim 4, wherein applying the plurality of matching rules to the plurality of account data comprises at least one of:
comparing a plurality of account identification attributes of the plurality of account data according to a plurality of comparison rules to determine a probability of a match between the first account and the second account;
customizing the plurality of comparison rules by assigning a quality-of-match level for at least one account identification attribute of the plurality of account identification attributes;
analyzing at least one of a business data obtained from a secondary data source and personal data obtained from the secondary data source;
removing extraneous identifying information from the plurality of account data; standardizing the data format of the plurality of account data;
including multiple addresses per account;
updating the plurality of account data based on merger, acquisition, and divestiture data;
obtaining business data from an external data source;
obtaining business data for a prospective customer;
making multiple passes through the account data to maximize a match rate; and
selectively applying matching rules in accordance with at least one of a type of the account and a type of a business unit of the at least one business customer.

6. (canceled)

7. The method of claim 1, further comprising:
applying a data feedback loop to identify a data anomaly, wherein the data anomaly comprises at least one of a proprietary linkage, a questionable linkage, a questionable hierarchy, a questionable data quality of external data, a questionable data quality of internal data, and a data inconsistency;
determining a source of the data anomaly, wherein the source of the data anomaly comprises at least one of an effectiveness of a linking rule, a requirement for the linking rule, a misapplication of the linking rule, an effectiveness of a hierarchy rule, a requirement for the hierarchy rule, a misapplication of the hierarchy rule, a data error in an external data source, and a data error in an internal data source; and
rectifying the source of the data anomaly by at least one of adding the linking rule, modifying the linking rule, deleting the linking rule, adding the hierarchy rule, modifying the hierarchy rule, deleting the hierarchy rule, changing the application of the linking rule, changing the application of the hierarchy rule, changing a parameter of the linking rule, changing a parameter of the hierarchy rule, correcting an error in the external data, and correcting an error in the internal data.

8. (canceled)

9. The method of claim 7, further comprising generating a report indicative of at least one of a data input, a data input quality, a data output, a data output quality, a result of an application of the linking rule, and a result of an application of the hierarchy rule.

10. The method of claim 1, wherein creating the hierarchical relationship between at least the account of the first location and at least the account of the second location comprises at least one of:
creating a hierarchical relationship based on an organizational structure of the at least one business customer; and
creating a hierarchical relationship based on a financial transaction of the accounts of the at least one business customer with a common financial structure.

11. The method of claim 1, wherein creating the hierarchical relationship between at least the account of the first location and at least the account of the second location comprises:
creating a first set of hierarchical account relationships based on a first hierarchical criteria;
creating a second set of hierarchical account relationships based on a second hierarchical criteria, wherein the second hierarchical criteria is different from the first hierarchical criteria;
comparing the first set of hierarchical account relationships with the second set of hierarchical account relationships to detect an inconsistency between the first set and the second set; and
detecting at least one of an erroneous business data, an erroneous linking rule, and an erroneous hierarchy rule based on the inconsistency between the first set and the second set.

12. The method of claim 1, wherein capturing business demographics for the linked accounts of the at least one business customer comprises:
capturing at least one of demographic information, number of years in business, an industry code, an industry code with an extension, an executive, a business revenue, and an employee count of the at least one business customer; and
refreshing the at least one of demographic information, number of years in business, the industry code, the industry code with an extension, the executive, the business revenue, and the employee count periodically to track at least one of a growth of the business and a deterioration of the business.

13. A system for managing accounts stored by an enterprise, wherein said accounts are accounts of at least one business customer of a plurality of business customers of the enterprise, comprising:
a processor; and
a memory in communication with the processor, the memory storing a plurality of processing instructions for directing the processor to:
(a) identify a plurality of accounts associated with a single location of the at least one business customer;
(b) link the plurality of accounts associated with the single location;
(c) repeat steps (a) and (b) for a plurality of single locations of the at least one business customer, wherein a first identification and linkage is made to link a plurality of accounts of a first location of the at least one business customer and a second identification and linkage is made to link a plurality of accounts of a second location of the at least one business customer;
(d) create a hierarchical relationship between at least an account of the first location and at least an account of the second location; and
(e) capture business demographics for the linked accounts of the at least one business customer.

14. The system of claim 13, further comprising instructions for directing the processor to:
(f) identify a first account of the plurality of business customers of the enterprise and a second account of the plurality of business customers of the enterprise;
(g) determine that the first account is not linked to the second account;
(h) determine that the first account is not in a hierarchical relationship with the second account;
(i) determine according to a plurality of association rules that an association exists between the first account and the second account; and
(j) create an associative link between the first account and the second account.

15. The system of claim 14, wherein the instructions for directing the processor to determine according to a plurality of association rules that an association exists between the first account and the second account comprise at least one of instructions for directing the processor to:
(k) determine that the first account and the second account are accounts of a common person;
(l) determine that the first account and the second account are accounts sharing a common business interest;
(m) determine that the first account and the second account are accounts sharing a common demographic;
(n) determine that the first account and the second account are accounts of a respective first business and second business wherein the first business and the second business are at least one of commonly owned businesses or associated businesses;
(o) determine that the first account and the second account are accounts of a respective first business unit and a respective second business unit of a common business, where a rule exists to not link accounts between the first business unit and the second business unit; and
(p) determine that the first account and the second account are accounts of a respective first person and second person wherein the first person is associated with the second person through at least one of a common business dealing, a common business association, or a common personal association.

16. The system of claim 13, wherein the instructions for directing the processor to link the plurality of accounts associated with the single location comprise instructions for directing the processor to:
(f) apply a plurality of matching rules to a plurality of account data, wherein a first account of the plurality of accounts of the single location is matched to a second account of the plurality of accounts of the single location; and
(g) link the first account with the second account by assigning a common identification value to the first account and the second account.

17. The system of claim 16, wherein the instructions for directing the processor to apply the plurality of matching rules to the plurality of account data comprise at least one of instructions for directing the processor to:
(h) compare a plurality of account identification attributes of the plurality of account data according to a plurality of comparison rules to determine a probability of a match between the first account and the second account;
(i) customize the plurality of comparison rules by assigning a quality-of-match level for at least one account identification attribute of the plurality of account identification attributes;
(j) analyze at least one of a business data obtained from a secondary data source and a personal data obtained from the secondary data source;
(k) remove extraneous identifying information from the plurality of account data;
(l) standardize the data format of the plurality of account data;
(m) include multiple addresses per account;
(n) update the plurality of account data based on merger, acquisition, and divestiture data;
(o) obtain business data from an external data source;
(p) obtain business data for a prospective customer;
(q) make multiple passes through the account data to maximize a match rate; and
(r) selectively apply the matching rules in accordance with at least one of a type of the account and a type of a business unit of the at least one business customer.

18. (canceled)

19. The system of claim 13, further comprising instructions for directing the processor to:
(f) apply a data feedback loop to identify a data anomaly, wherein the data anomaly comprises at least one of a proprietary linkage, a questionable linkage, a questionable hierarchy, a questionable data quality of external data, a questionable data quality of internal data, and a data inconsistency;
(g) determine a source of the data anomaly, wherein the source of the data anomaly comprises at least one of an effectiveness of a linking rule, a requirement for the linking rule, a misapplication of the linking rule, an effectiveness of a hierarchy rule, a requirement for the hierarchy rule, a misapplication of the hierarchy rule, a data error in an external data source, and a data error in an internal data source; and
(h) rectify the source of the data anomaly by at least by at least one of adding the linking rule, modifying the linking rule, deleting the linking rule, adding the hierarchy rule, modifying the hierarchy rule, deleting the hierarchy rule, changing the application of the linking rule, changing the application of the hierarchy rule, changing a parameter of the linking rule, changing a parameter of the hierarchy rule, correcting an error in the external data, and correcting an error in the internal data.

20. (canceled)

21. (canceled)

22. The system of claim 13, wherein the instructions of step (d) for directing the processor to create the hierarchical relationship between at least the account of the first location and at least the account of the second location comprise at least one of:
(f) instructions for directing the processor to create a hierarchical relationship based on an organizational structure of the at least one business customer; and
(g) instructions for directing the processor to create a hierarchical relationship based on a financial transaction of the accounts of the at least one business customer with a common financial structure.

23. The system of claim 13, wherein the instructions of step (d) for directing the processor to create the hierarchical relationship between at least the account of the first location and at least the account of the second location comprise instructions for directing the processor to:
(f) create a first set of hierarchical account relationships based on a first hierarchical criteria;
(g) create a second set of hierarchical account relationships based on a second hierarchical criteria, wherein the second hierarchical criteria is different from the first hierarchical criteria;
(h) compare the first set of hierarchical account relationships with the second set of hierarchical account relationships to detect an inconsistency between the first set and the second set; and
(i) detect at least one of an erroneous business data, an erroneous linking rule, and an erroneous hierarchy rule based on the inconsistency between the first set and the second set.

24. The system of claim 13, wherein the instructions for directing the processor to capture business demographics for the linked accounts of the at least one business customer comprise:
(f) instructions for directing the processor to capture at least one of demographic information, number of years in business, an industry code, an industry code with an extension, a highest ranking official, a business revenue, and an employee count of the at least one business customer; and
(g) instructions for directing the processor to refresh the at least one of demographic information, number of years in business, the industry code, the industry code with an extension, the executive, the business revenue, and the employee count periodically to track at least one of a growth of the business and a deterioration of the business.

25. A computer program product comprising a computer usable medium having control logic stored therein for causing a computer to manage accounts stored by an enterprise, wherein said accounts are accounts of at least one business customer of a plurality of business customers of the enterprise, said control logic comprising:
first computer readable program code means for causing the computer to identify a plurality of accounts associated with a single location of the at least one business customer;
second computer readable program code means for causing the computer to link the plurality of accounts associated with the single location;
third computer readable program code means for causing the computer to repeat said identifying and linking steps for a plurality of single locations of the at least one business customer, wherein a first identification and linkage is made to link a plurality of accounts of a first location of the at least one business customer and a second identification and linkage is made to link a plurality of accounts of a second location of the at least one business customer;
fourth computer readable program code means for causing the computer to create a hierarchical relationship between at least an account of the first location and at least the account of a second location;
fifth computer readable program code means for causing the computer to capture business demographics for the linked accounts of the at least one business customer; and
sixth computer readable program code means for causing the computer to determine for a first account which is not linked to a second account and which is not in a hierarchical relationship with the second account that an association exists between the first account and the second account, and for causing the computer to create an associative link between the first account and the second account.

26. The computer program product of claim 25, wherein said second computer readable program code means comprises:
seventh computer readable program code means for causing the computer to apply a plurality of matching rules to a plurality of account data, wherein a first account of the plurality of accounts of the single location is matched to a second account of the plurality of accounts of the single location; and
eighth computer readable program code means for causing the computer to link the first account with the second account by assigning a common identification value to the first account and the second account.

27. The computer program product of claim 26, wherein said seventh computer readable program code means comprises at least one of:
ninth computer readable program code means for causing the computer to compare a plurality of account identification attributes of the plurality of account data according to a plurality of comparison rules to determine a probability of a match between the first account and the second account;
tenth computer readable program code means for causing the computer to customize the plurality of comparison rules by assigning a quality-of-match level for at least one account identification attribute of the plurality of account identification attributes;
eleventh computer readable program code means for causing the computer to analyze at least one of a business data obtained from a secondary data source and a personal data obtained from the secondary data source;
twelfth computer readable program code means for causing the computer to remove extraneous identifying information from the plurality of account data;
thirteenth computer readable program code means for causing the computer to standardize the data format of the plurality of account data;
fourteenth computer readable program code means for causing the computer to include multiple addresses per account;
fifteenth computer readable program code means for causing the computer to update the plurality of account data based on merger, acquisition, and divestiture data;
sixteenth computer readable program code means for causing the computer to obtain business data from an external data source;
seventeenth computer readable program code means for causing the computer to obtain business data for a prospective customer; and
and
eighteenth computer readable program code means for causing the computer to make multiple passes through the account data to maximize a match rate.

28. The computer program product of claim 26, further comprising:
ninth computer readable program code means for causing the computer to apply a data feedback loop to identify a data anomaly, wherein the data anomaly comprises at least one of a proprietary linkage, a questionable linkage, a questionable hierarchy, a questionable data quality of external data, a questionable data quality of internal data, and a data inconsistency;
tenth computer readable program code means for causing the computer to determine a source of the data anomaly, wherein the source of the data anomaly comprises at least one of an effectiveness of a linking rule, a requirement for the linking rule, a misapplication of the linking rule, an effectiveness of a hierarchy rule, a requirement for the hierarchy rule, a misapplication of the hierarchy rule, a data error in an external data source, and a data error in an internal data source; and
eleventh computer readable program code means for causing the computer to rectify the source of the data anomaly by at least by at least one of adding the linking rule, modifying the linking rule, deleting the linking rule, adding the hierarchy rule, modifying the hierarchy rule, deleting the hierarchy rule, changing the application of the linking rule, changing the application of the hierarchy rule, changing a parameter of the linking rule, changing a parameter of the hierarchy rule, correcting an error in the external data, and correcting an error in the internal data.

29. The computer program product of claim 28, wherein the ninth computer readable program code means for causing the computer to apply the data feedback loop to identify the data anomaly comprises at least one of:
twelfth computer readable program code means for causing the computer to apply an automated data auditing rule to a linking process output;
thirteenth computer readable program code means for causing the computer to present a user-interface means for a human operator to audit the linking process; and
fourteenth computer readable program code means for causing the computer to generate a report indicative of at least one of a data input, a data input quality, a data output, a data output quality, a result of an application of the linking rule, and a result of an application of the hierarchy rule.

30. The computer program product of claim 25, wherein said fourth computer readable program code means for causing the computer to create the hierarchical relationship between at least the account of the first location of the at least one business customer and at least the account of the second location of the at least one business customer comprises:
seventh computer readable program code means for instructing the processor to create a first set of hierarchical account relationships based on a first hierarchical criteria, wherein the first hierarchical criteria comprises at least one of:
an organizational structure of the at least one business customer; and
a financial transaction of the accounts of the at least one business customer with a common financial structure;
eighth computer readable program code means for instructing the processor to create a second set of hierarchical account relationships based on a second hierarchical criteria, wherein the second hierarchical criteria is different from the first hierarchical criteria and wherein the second hierarchical criteria comprises at least one of:
an organizational structure of the at least one business customer; and
a financial transaction of the accounts of the at least one business customer with a common financial structure;
ninth computer readable program code means for instructing the processor to compare the first set of hierarchical account relationships with the second set of hierarchical account relationships to detect an inconsistency between the first set and the second set; and
tenth computer readable program code means for instructing the processor to detect at least one of an erroneous business data, an erroneous linking rule, and an erroneous hierarchy rule based on the inconsistency between the first set and the second set.
